(19) United States
(12) Patent Application Publication
(10) Pub. No.: US 2026/0310405 A1
(43) Pub. Date: Oct. 8, 2026

(54) Integrating Large Language Models with Multimodal Virtual Reality Interfaces To Support Collaborative Human-Robot Construction Work

(71) Applicant: REGENTS OF THE UNIVERSITY OF MICHIGAN, Ann Arbor, MI (US)

(72) Inventors: Carol C. Menassa, Ann Arbor, MI (US); Vineet R. Kamat, Ann Arbor, MI (US); Somin Park, Arlington, TX (US); Joyce Y. Chai, Ann Arbor, MI (US)

(21) Appl. No.: 19/639,096

(22) Filed: Apr. 3, 2026

Related U.S. Application Data
(60) Provisional application No. 63/783,825, filed on Apr. 4, 2025.

(51) Int. Cl. G06F 3/16; G06F 3/01; G06T 11/60

(52) U.S. Cl. CPC G06F 3/167; G06F 3/017; G06T 11/60

(57) ABSTRACT

A system includes a processor and memory with instructions that, when executed, cause the system to accept speech and gesture inputs, generate integrated task instructions, retrieve data from a building model, verify the task instructions via user confirmation, validate constraints, and transmit execution parameters to a robotic control system for virtual construction tasks. A computer-implemented method includes accepting speech and gesture inputs, generating integrated task instructions, retrieving data from a building model, verifying user confirmation, validating constraints, and transmitting parameters for simulated construction tasks. A computer-readable medium includes instructions that cause a computer to accept speech and gesture inputs, process and integrate task instructions, retrieve building model data, confirm user intentions, validate constraints, and output commands for simulated robotic execution.

### CROSS-REFERENCE TO RELATED APPLICATIONS

This application claims priority to U.S. Provisional Patent Application No. 63/783,825, titled “Integrating Large Language Models with Multimodal Virtual Reality Interfaces to Support Collaborative Human-Robot Construction Work,” filed Apr. 4, 2025, which is hereby incorporated by reference in its entirety.

### STATEMENT REGARDING FEDERALLY SPONSORED RESEARCH OR DEVELOPMENT

This invention was made with government support under 2025805, and 2128623 awarded by the National Science Foundation. The government has certain rights in the invention.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Conventional work in construction robotics and human-machine communication often relies on single modalities, such as voice or text interfaces, for task execution. Systems using only speech inputs have encountered challenges when requiring users to articulate detailed commands, with ambiguity and specificity sometimes limiting effective task performance. Traditional approaches aiming for bidirectional interactions have largely focused on query-response mechanisms without fully leveraging the potential of nonverbal cues, like hand gestures, that can provide more intuitive spatial references.

Existing platforms in the architecture, engineering, and construction fields typically integrate discrete software components for modeling, visualization, and robotic control, but they have not consistently incorporated multiple channels of user input within immersive environments. Continuous reliance on predefined templates and single-mode communications can lead to increased cognitive load and misinterpretations in dynamic and complex work settings, highlighting opportunities for improved platforms and technologies for solving the identified conventional problems.

Below is an overview and discussion on integrating large language models (LLMs) with multimodal virtual reality (VR) interfaces to support collaborative human-robot construction work. This concept combines advanced natural language understanding with immersive, interactive environments to enhance how humans and robots work together in construction settings.

### BRIEF SUMMARY OF THE INVENTION

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

In one aspect, a computing system having a processor and a memory includes computer-executable instructions that, when executed, cause the computing system to: (1) accept input commands comprising speech and gesture inputs to specify task parameters within a virtual environment; (2) combine the speech inputs with gesture-based inputs to generate integrated task instructions; (3) retrieve object and environmental data from a building information model associated with the virtual environment; (4) verify the integrated task instructions by soliciting user confirmation of parameters interpreted from the integrated task instructions; (5) validate constraints related to the task instructions using object and environmental data; and (6) transmit confirmed task execution parameters to a robotic control system for performing tasks in a virtual representation of a construction site.

In another aspect, a computer-implemented method includes: (1) accepting input commands comprising speech and gesture inputs to specify task parameters within a virtual environment; (2) combining the speech inputs with gesture-based inputs to generate integrated task instructions; (3) retrieving object and environmental data from a building information model associated with the virtual environment; (4) displaying a confirmation prompt to verify parameters interpreted from the integrated task instructions; (5) validating constraints related to the task instructions using object and environmental data; and (6) transmitting confirmed task parameters to a robotic control system for execution within a construction simulation.

In yet another aspect, a computer-readable medium includes instructions that, when executed, cause a computer to: (1) accept user commands comprising speech and gesture inputs to specify virtual tasks; (2) process and integrate speech and gesture inputs into task instructions; (3) retrieve relevant object and contextual data from a building information model; (4) confirm user intentions by verifying interpreted task details through user interaction; (5) validate the task against operational constraints; and (6) output commands to a robotic system for simulated task execution.

Advantages will become more apparent to those of ordinary skill in the art from the following description of the preferred embodiments, which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF FIGURES

The figures described below depict various aspects of the system and methods disclosed herein. It should be understood that each figure depicts an embodiment of a particular aspect of the disclosed system and methods, and that each of the figures is intended to accord with a possible embodiment thereof.

There are shown in the drawings arrangements which are presently discussed, it being understood, however, that the present embodiments are not limited to the precise arrangements and instrumentalities shown, wherein:

FIG. 1 depicts a multimodal interaction system that integrates natural language processing, multimedia visualization, and robotic control within a virtual reality environment for human-robot collaboration in construction, according to some aspects.

FIG. 2 depicts the data flow and software architecture of a multimodal human-robot collaboration system integrating speech, user controllers, building information modeling (BIM) data, and language model-supported bidirectional communication, according to some aspects.

FIG. 3 depicts an integration of voice commands and VR controller inputs for intuitive user engagement in a virtual reality environment, according to some aspects.

FIG. 4 depicts the transfer and rendering of BIM data from a BIM application workspace to a 3D rendering platform, enabling dynamic 3D visualization, according to some aspects.

FIG. 5 depicts a user-driven process whereby task instructions are reviewed, confirmed, or clarified prior to robotic execution, according to some aspects.

FIG. 6 depicts an exemplary prompt designed to enable effective communication and task coordination between a human operator and a robot in a construction environment, according to some aspects.

FIG. 7 depicts a virtual reality environment implemented in a 3D rendering platform, featuring immersive visualizations and user interactivity to facilitate human-robot collaboration, according to some aspects.

FIG. 8 depicts verbal and multimodal experimental interaction modes aimed at evaluating language model-driven error detection and correction during construction tasks in VR, according to some aspects.

FIG. 9 depicts a structured prompt for generating step-by-step drywall installation instructions with high technical specificity, according to some aspects.

FIG. 10 depicts a timeline of sequential procedural stages for an experimental evaluation of a multimodal interaction system, according to some aspects.

FIG. 11 depicts a comparison of perceived workload assessments for speech and multimodal interaction methods based on NASA-TLX metrics, according to some aspects.

FIG. 12 depicts mean workload scores comparing speech and multimodal interaction methods, indicating substantial equivalence in user workload experiences, according to some aspects.

FIG. 13 depicts average usability ratings for speech-based and multimodal interaction methods, showing high usability scores for both approaches, according to some aspects.

FIG. 14 depicts exemplary user-language model system conversations, including responses to blank user inputs, highlighting the system's robustness in handling incomplete instructions, according to some aspects.

FIG. 15 depicts the detection and rectification of erroneous installation instructions within a language model system for real-time user guidance, according to some aspects.

FIG. 16 depicts examples of failures by a language model-driven system to identify and address inconsistencies in construction task instructions, according to some aspects.

FIG. 17 depicts a method for specifying and validating task parameters using multimodal inputs within a virtual environment to facilitate robotic execution of construction tasks, according to some aspects.

FIG. 18 depicts a computing environment for integrating speech, gestures, and BIM data within a virtual reality interface to support human-robot collaboration in construction scenarios, according to some aspects.

### DETAILED DESCRIPTION

The present techniques relate to a bidirectional interaction system designed for human-robot collaboration (HRC) in construction tasks. The system integrates speech-based commands with supplemental inputs from a handheld controller and employs an intelligent virtual assistant powered by a large language model to facilitate accurate communication, error detection, and corrective feedback during robot task execution.

In some aspects, a human operator may be responsible for issuing commands to the robot, verifying the robot's interpretation of these commands, and supervising task execution. A chat system may be configured to detect and rectify potential errors (e.g., inaccuracies from speech-to-text (STT) conversion or misinterpretation by the chat module) by facilitating a clear bidirectional exchange between the human operator and the robot.

Motion planning within the system may adhere to collision-free path design, helping to ensure that the robot and any workpiece avoid collisions with environmental obstacles. The calculated motion plans may be implemented in a simulation environment where a virtual robot mimics the planned movements based on joint state data transmitted from a robot operating system (ROS). This framework may be applicable to a variety of construction robotics applications.

In some aspects, an experimental setup may evaluate the efficacy of combining speech and hand-controller inputs in enhancing HRC, and assess the precision of bidirectional interaction enabled by the virtual assistant. In one example, twelve construction workers interacted with a virtual robot within a simulated construction environment, visualized through a VR headset. This environment featured elements such as a stud frame and drywall panels identifiable by a three-digit ID. The scope of the robot's actions in the experiment was limited to ‘pick-up’ and ‘place’ tasks. The test scenario involved installing drywall panels on studs with both speech-only and multimodal (speech plus handheld controller) inputs. Participants were explicitly instructed to include intentional errors during interaction. The errors included mismatched panel-stud pairings, references to non-existent objects, instructions involving already positioned items, and incomplete or duplicate directives. This aspect may be designed to assess the language model-powered virtual assistant's capability to detect and correct interaction errors effectively.

By outlining the roles of the human operator, the bidirectional communication strategy, the approach to motion planning and robot control, as well as a detailed experimental case study, this disclosure provides comprehensive insight into the evaluation and potential impact of this multimodal interaction system on improving robotic task performance in construction settings.

The present techniques include a multimodal interaction system designed to enhance human-robot collaboration (HRC) in construction through an integrated VR and chat application interface. The system may provide low workload and high usability for construction tasks such as drywall installation. Further research to assess the system across a broader range of construction tasks and to automate information retrieval processes is envisioned.

The present techniques may integrate multiple computational components to facilitate a conversational interface in a virtual environment for collaborative work. A virtual environment may present immersive scenery that includes construction elements, robotic units, and other project details. A speech input may capture audible commands from a user. A handheld controller may allow the user to designate objects within the display, such as materials or structural elements. A large language model may then parse text to interpret the user's requests. A BIM module may supply information about construction items, while a game engine may render three-dimensional representations and manage interactive controls. A robot operating system may orchestrate motion planning and robot control, and a bridging module (e.g., Rosbridge) may link the game engine to the robot operating system through messages passed over a network. A chat interface may manage text-based communication by verifying user instructions and requesting clarifications when input information appears incomplete or ambiguous. A user device may present the immersive visual field, collect audio, and convey user commands to other components/systems. A memory storage unit may maintain relevant data, including object IDs and other semantic details for construction items. A processor may coordinate these components, executing speech recognition, integration of semantics, and control signals for a robotic arm or other automated equipment.

This arrangement may address situations in building industries, where operators frequently interact with unstructured and potentially demanding tasks. Users may coordinate with robots, request that materials be moved, or direct automated processes to assist in completing difficult activities. The aspects described here may solve difficulties caused by unclear instructions, complicated safety concerns, or data fragmentation. By relying on a game engine and a BIM module, the system may display detailed geometry and semantic features associated with each piece of scaffolding, structural framing, panel element, or other construction component. Users may benefit from the capacity of the handheld controller to reduce the need for explicit numeric or textual calls for object IDs. Instead, the user may identify targets by pointing or aiming a controller beam at a specific piece of material. The speech input may then capture a spoken command, and the large language model may align this information with the recognized objects. In that manner, the user may produce concise interactions, such as “Pick this and place it here,” while the system delivers a text message with precise IDs to the chat interface. The chat interface may request confirmation from the user, thereby reducing errors caused by miscommunication.

A user study described in the disclosure indicates that twelve participants, each with prior construction experience, tested the arrangement by completing a drywall installation scenario in a virtual environment. Participants wore a head-mounted display and used the handheld controller while conversing with the large language model through the speech input. Users issued instructions in two modes: one relied on speech commands referencing item IDs, and the other used a combination of speech and controller selection. Participants also received chat-based messages about the interpretation of their own commands, prompting them to confirm or correct the system's assumptions. When users intentionally provided incorrect directives, the chat interface used the large language model to detect inconsistencies and request clarifications. Some aspects involved incomplete or contradictory instructions, such as specifying two different material IDs or referring to items that did not exist within the BIM module. In most cases, the chat interface reported mismatches, confirmed the user's ultimate choice, and guided the robot operating system to execute the corresponding action.

The benefits of the disclosed techniques may extend to increased accuracy of collaborative tasks, because the chat interface can engage the user in a confirmation step, thereby reducing mistakes in real-world construction or simulated processes. The coordination among speech input, handheld controller, and large language model may allow each request to be parsed more effectively, which may relieve the mental burden on personnel who would otherwise provide precise object descriptions or numeric IDs. By combining multiple modalities, the approach may deliver a sense of immersion that enhances user engagement. A user may perceive greater agency when pointing to an object and stating a command, rather than navigating cumbersome menus or typing. Such direct interaction may be especially helpful in noisy or complex construction environments, where quick reference disambiguation may allow users to focus on safety and efficiency.

The present techniques may provide several enhancements to computer operations. One enhancement relates to improved processing by offloading inaccurate or partial instructions to a large language model that runs on a processor or a remote system. The large language model may take advantage of advanced parallelization or distributed computational resources, which may reduce latency when it interprets commands. By leveraging multiple hardware threads or dedicated GPU resources, the system may promote quick recognition of user inputs, which helps keep interactions smooth. This refined approach to processing may lessen the load on local computing by transferring select tasks to a server or a cluster, if so configured. When users provide a steady flow of speech or controller input, the system may allocate computing resources dynamically. The chat interface may queue requests and coordinate concurrency, which may lead to higher throughput compared to a single-mode command scenario. In that sense, computing resources may be allocated more efficiently because the system can handle multiple tasks concurrently without forcing the user to wait excessively. These design choices may allow the technique to scale.

Another enhancement may relate to improvements in network usage. The bridging module may utilize robust protocols to transmit relevant messages between the game engine and the robot operating system, for example, in a structured message format (e.g., JSON). Because the system may clarify tasks before sending final instructions, it can avoid sending extraneous or ambiguous requests over the network. This practice may reduce bandwidth consumption. The bridging module may bundle relevant data in single transmissions, which may minimize overhead and packet fragmentation. Also, the approach may reduce repeated guesswork by confirming or discarding unclear inputs early, thereby decreasing unnecessary data flows. When the bridging module relays motion planning data, the system may track states and only update incremental changes. This approach may help reduce excessive communication overhead, because the bridging module does not constantly resend large volumes of 3D geometry or redundant sensor information. Consequently, connected systems may experience more stable throughput.

A further enhancement may pertain to smarter memory usage. The system may store references to building materials in a central database, with each item associated with geometry, attributes, and usage history. When the user designates an object with the handheld controller, the system may map the object's ID to the stored record in the memory storage unit. Because that record may incorporate physical dimensions, material properties, and preconfigured location data, each reference may be retrieved on demand without forcing the entire geometry to be reloaded. The memory storage unit may maintain a cache of frequently accessed items, so repeated queries for particular panels or studs may remain localized. The chat interface may also reference partial or previous instructions from the memory storage unit. Whenever the user attempts to reuse an object that the system identifies as already installed, the system may flag the mismatch without scanning an entire data set from scratch. This incremental approach may reduce memory and processing overhead. At the same time, the BIM module may accommodate a large set of potential materials or structures without incurring performance penalties from continuous scanning. In many cases, the system may coordinate these memory requests in parallel with language processing tasks, because the large language model may only require textual references to object IDs rather than the raw geometry. This synergy may help reduce extensive duplication of data and thereby free memory resources for other processes like rendering, speech recognition, or motion planning.

The chat interface may prompt users to confirm a proposed interpretation, which may foster a sense of transparency about what tasks the system plans to execute. By combining an audio-based mode with a precise pointing mechanism, the approach may improve clarity of references to objects or actions. Users no longer rely on lengthy instructions like “pick up the sheet labeled 500300,” because they may point to a sheet in the immersive display. This design may be beneficial in scenarios where ambiguous descriptions arise due to differences in naming conventions or numbering schemes. The handheld controller may reduce the chance of referencing the incorrect item. Meanwhile, the speech input may allow flexible phrasing, and the large language model may parse varying syntaxes or incomplete references. The chat interface may then complete the loop by requesting correction if the described item does not match existing data.

The techniques described herein may adapt to various tasks in construction, beyond drywall installations. The BIM module may integrate relevant site details for steel erection or mechanical assemblies. The user may direct robots to lift heavy columns or position piping. The system may also apply to additional domains where safe and accurate robot collaboration is helpful, including welding or inspection. Developers may swap out the large language model for another textual interpreter, or they may integrate an alternative voice recognition system. The bridging module may connect to a range of robotic configurations, such as tracked mobile manipulators or swarm units. Users might add specialized data to the memory storage unit (e.g., to handle tasks requiring environmental sensors or geolocation references).

The following sections may describe in detail how these and other elements cooperate to address high-level goals in tasks where a human operator directs a robotic unit through intuitive multimodal interaction. This arrangement may allow flexible and efficient workflows, reduce user cognitive strain, and enhance the accuracy of tasks in construction or similar fields.

### Example Computing Environment

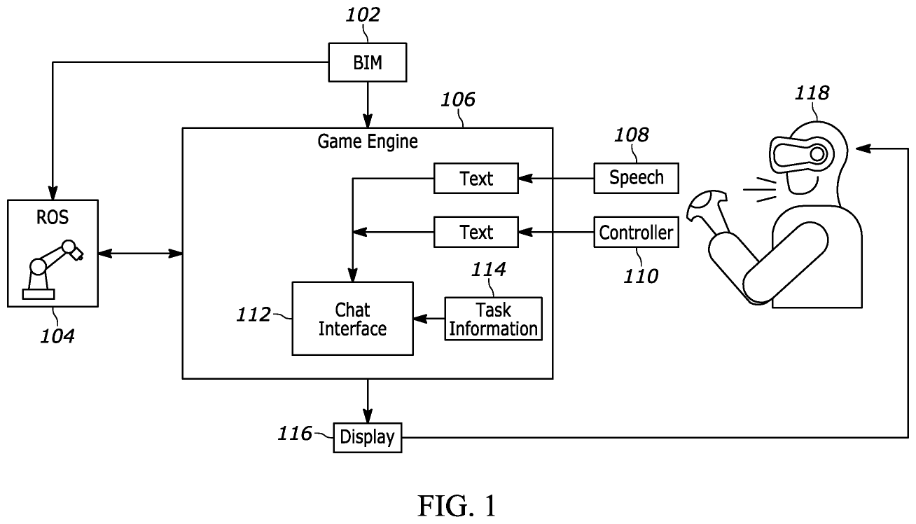

FIG. 1 depicts a schematic diagram of a computing framework for a multimodal interaction system in a virtual reality (VR) environment for human-robot collaboration in construction applications, according to some aspects. In one exemplary embodiment, the system may integrate multiple components, including user interaction channels, a Robot Operating System (ROS) 104, a Building Information Modeling (BIM) module 102, and a game engine 106 that together facilitate intuitive and efficient human-robot control.

As illustrated, the system receives input from two primary channels: speech input 108 and controller input 110 (e.g., physical controllers). These inputs may serve as multimodal data sources that are subsequently processed by a chat interface 112 embedded within the game engine 106. The chat interface 112 may interpret natural language commands, thereby enabling a human operator 118 to interact seamlessly with a construction robot through the use of conversational commands.

The game engine 106 may play a dual role. First, it renders visualizations of the construction site by incorporating 3D geometric information and semantic details extracted from the BIM module 102. This visualization may allow users to perceive the current status and structure of the construction environment and may also provide contextual task information 114 regarding building materials and other site attributes. Second, the game engine 106 may operate as an intermediary control layer interfacing with the ROS 104. Through this integration, commands issued via the chat interface 112 may be communicated to the robot, enabling real-time robot control and thereby closing the loop of human-robot collaboration (HRC). A display 116 renders the visual output from the game engine 106 and provides feedback to the operator 118.

The illustrated framework in FIG. 1 thereby demonstrates that a convergence of speech input 108 and controller input 110, multimedia visualization of construction data, and real-time robotic control via ROS 104 may result in a robust system for multimodal interaction in VR. This design may allow for enhanced intuitive interaction with construction robots, streamlining operations within complex construction environments while ensuring that user commands are effectively translated into robotic actions. The system of FIG. 1 provides a detailed block diagram of a multimodal interaction system that integrates natural language processing, interactive visual rendering, and robotic control, thereby enabling a continuous and efficient loop of human-robot interaction in a construction context.

### Example Data Flow and Software Integration Architecture

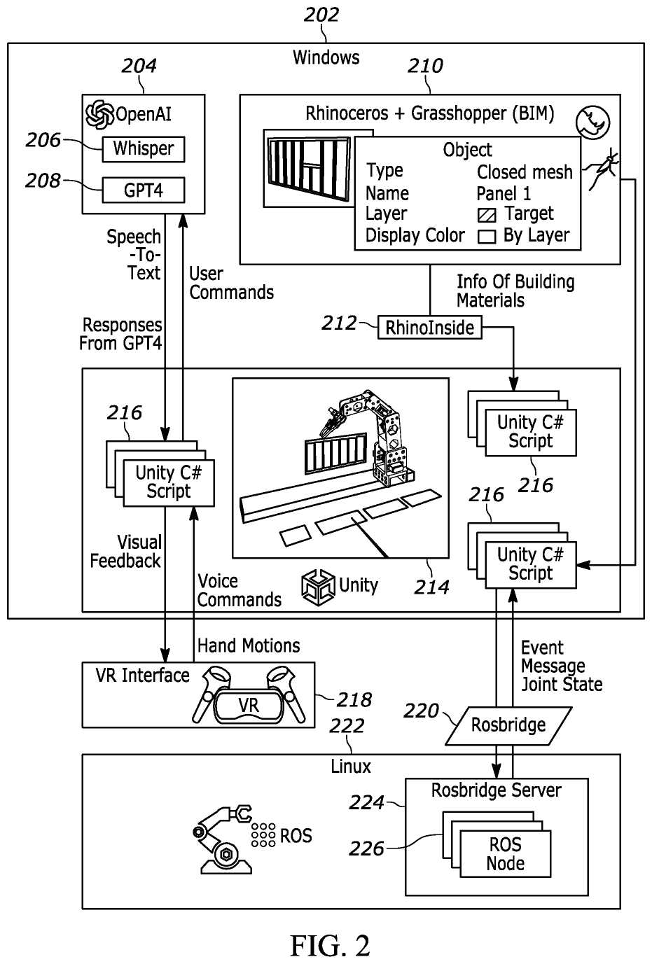

FIG. 2 is a schematic representation of an exemplary data flow and software integration architecture for the proposed multimodal interaction system designed for human-robot collaboration (HRC) of FIG. 1, according to some aspects. As illustrated, FIG. 2 may delineate the interconnections between various system components and the pathways for data exchange that enable seamless integration of multiple input modalities and collaborative operations.

In one segment of the figure, the diagram may depict the integration strategy for two distinct user inputs: speech commands and handheld controllers, the latter being captured via a virtual reality (VR) interface 218. This approach is further enhanced by incorporating building material information retrieved from a BIM application 210 (e.g., Rhinoceros® and Grasshopper®). The integration of these heterogeneous data sources may provide a robust framework for interpreting user instructions and informing system behavior.

Another segment of FIG. 2 focuses on the interactive communication flow between a human operator and a robot. The architecture may outline a bidirectional communication channel implemented via a language model 208 (e.g., GPT-4), which supports natural language processing and decision-making functions. STT processing may be handled by a STT processing system 206 (e.g., Whisper) within a 3^{rd} party service 204 (e.g., OpenAI). The system may operate within a first computing environment 202 (e.g., Windows) that hosts the 3D game engine 214 (e.g., Unity®), which may also be referred to herein as a 3D rendering platform, and associated script(s) 216 (e.g., C #) for managing user commands and visual feedback. A BIM-game engine integration module 212 (e.g., Rhino. Inside®) enables concurrent operation between the BIM application and the game engine. This channel is integrated with the ROS within the 3D game engine 214 environment, with a ROS communication bridge 220 (e.g., Rosbridge) facilitating communication between the first computing environment 202 and a second computing environment 222 (e.g., Linux®) by exchanging event messages and joint state data. The second computing environment 222 includes a ROS communication bridge server 224 and ROS node(s) 226 for robot motion planning and control, thereby facilitating collaborative operations and real-time feedback between the human operator and the robotic system. FIG. 2 depicts data paths, module interconnections, and software integrations that form the foundation of the multimodal interaction system, and demonstrates the system's capacity for efficient, real-time human-robot collaboration in complex operational scenarios.

### Example Multimodal Input Integration

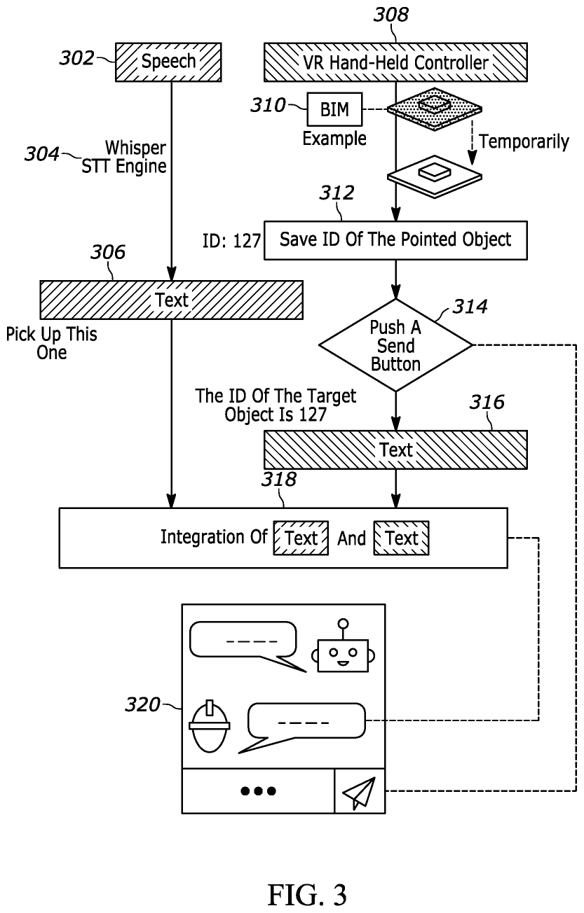

FIG. 3 illustrates a block flow diagram of a multimodal interaction system within a virtual reality (VR) environment, wherein voice commands and controller inputs are integrated to enable intuitive user engagement. In FIG. 3, a VR headset is adapted to capture voice commands via an onboard microphone. The captured audio is then routed to an automatic speech recognition (ASR) or STT engine 304 (e.g., OpenAI Whisper). The ASR may be trained on datasets including multilingual audio data, thus providing robust and accurate voice command recognition even under diverse linguistic conditions. The STT engine 304 converts the speech input 302 into text 306 for further processing.

Concurrently, the system supports interaction via VR controllers 308. Each controller may be configured with a ray interactor that projects a virtual beam extending from the controller. This ray interactor enables the user to point at objects within the virtual environment and select them from a distance. When an object is pointed at, BIM data 310 provides object identification information, and the system saves the ID of the pointed object 312. When the object is subsequently selected using the VR controller mechanism, the system provides immediate visual feedback by temporarily changing the color of the selected object (e.g., to red), thereby confirming successful engagement. The system holds the object ID in reserve until the user activates a send button 314. Upon activation, an object ID text 316 is generated that combines the object ID with a placeholder sentence. An input integration 318 block merges the transcribed text 306 with the object ID text 316 into a composite command. The resulting integrated command is delivered to a chat interface 320 for transmission to the robotic system. By combining the input from the voice command channel and controller-based object interaction, the system illustrated in FIG. 3 facilitates natural communication and precise control within the VR environment, enhancing the user experience.

### Example Bim Data Transfer and Rendering Pipeline

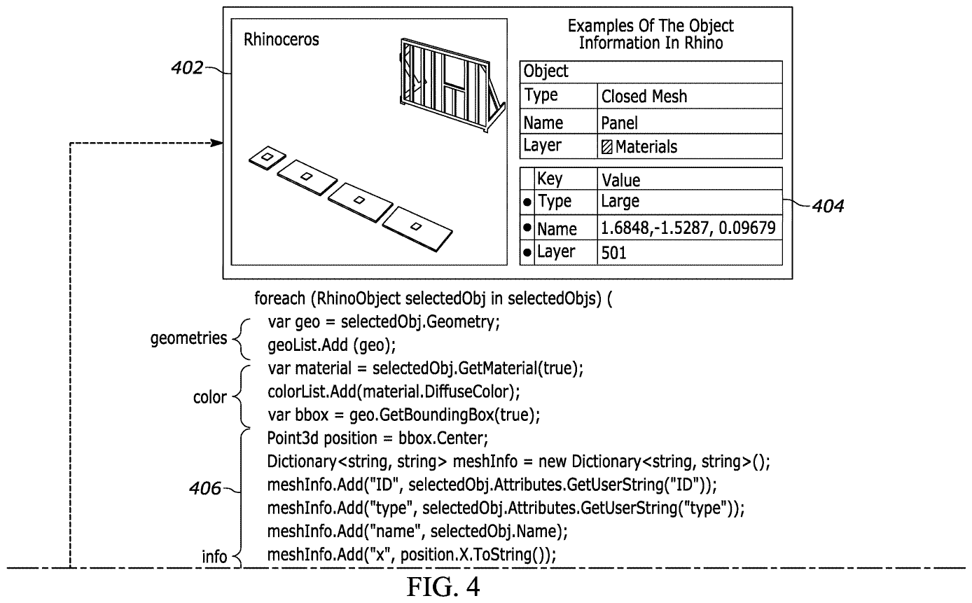

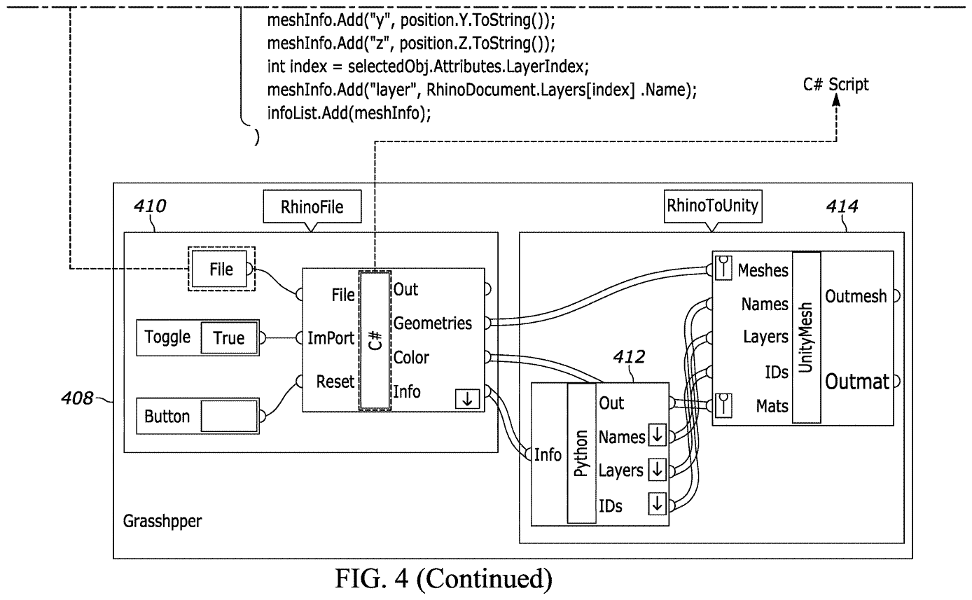

FIG. 4 illustrates a schematic block diagram of a system configured to transfer and render Building Information Modeling (BIM) data from a BIM application environment (e.g., Rhinoceros®) into a 3D rendering platform. A visual programming workspace 408 (e.g., Grasshopper) may be employed to partition and deliver the requisite BIM data via multiple processing blocks, thereby effectuating the communication between the BIM model 402 (e.g., a Rhinoceros® model) and the 3D rendering platform. The data packages transmitted include both geometric information and ancillary semantic attributes such as color, names, layers, and unique identifiers (IDs).

In the 3D environment, the 3D rendering platform may utilize the received data to instantiate 3D objects that are visually congruent with their corresponding counterparts in the BIM model 402. This congruence is achieved by preserving the original color information and geometric properties of each object, ensuring that the visual representation in the 3D rendering platform faithfully mirrors that of the BIM-generated model. An object information panel 404 displays example object metadata including type, name, layer, position, and ID fields retrieved from the BIM data. A script 406 (e.g., C #), as partially shown in FIG. 4, demonstrates the method by which various types of object data are extracted from the BIM model 402. The script highlights the process of interfacing with the BIM data, obtaining and parsing the semantic information, and subsequently using this data to construct the interactive elements within the 3D rendering platform.

Some aspects of the present techniques may extract and use semantic data including attributes such as object type and precise positional coordinates, for example, to facilitate more advanced interactions, including robotic manipulation or automated decision-making processes based on spatial and categorical metadata. Within the visual programming workspace, a BIM file import component 410 (e.g., for Rhino® files such as .3dm) imports BIM file data and outputs geometry, color, and information streams. A Python component 412 receives the information stream and parses it into discrete outputs including names, layers, and IDs. A BIM-to-rendering-platform conversion component 414 (e.g., a Rhino® to Unity® component) accepts meshes, names, layers, IDs, and materials, and converts them into compatible mesh and material outputs. FIG. 4 encapsulates the integration approach whereby the visual programming workspace 408 serves as an intermediary to convey detailed BIM information from the BIM model 402 to the 3D rendering platform, culminating in a dynamic and interactive 3D visualization environment that can be further expanded for complex robotic interactions.

Example Task Instruction Approval Process

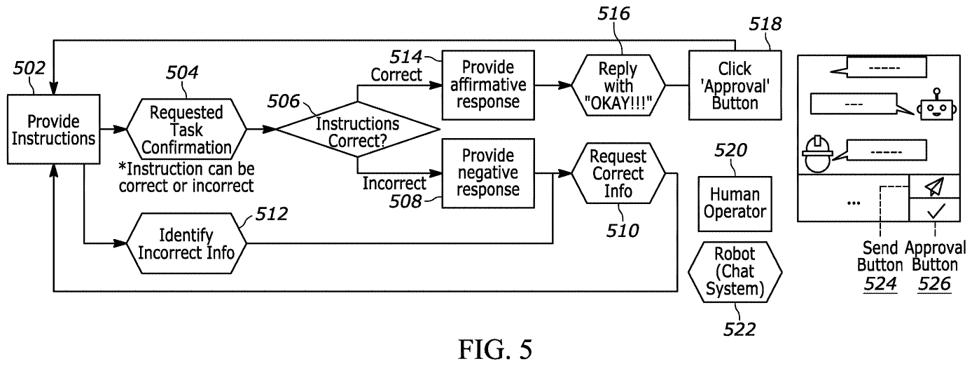

FIG. 5 is a flowchart of a computer-implemented method for enabling a human operator 520 to approve task instructions prior to robot execution. In this diagram, rectangles denote actions performed by the human operator 520, while hexagons depict the responses expected from the chat system 522. The process initiates when the human operator 520 provides instructions 502 (e.g., issues a set of instructions) that include specific, detailed information regarding the task to be performed. The chat system 522 then analyzes the provided instructions to extract the relevant information for task execution.

Subsequent to this analysis, the chat system 522 requests task confirmation 504 (e.g., issues a confirmation request) back to the human operator 520, presenting its interpretation of the task details. The human operator 520, acting as the ultimate decision-maker, reviews this interpretation at a decision point 506 (e.g., instructions correct?). If the human operator 520 agrees with the chat system 522's understanding, the human operator 520 provides an affirmative response 514 to the chat system 522. This response may trigger the chat system 522 to confirm with an explicit reply 516 (e.g., “OKAY!!!”). Following this acknowledgement, the human operator 520 finalizes the approval by clicking an ‘Approval’ button 526 on the chat interface 518. This action may signal to the robot that it may begin executing the task.

In an alternative scenario, if the human operator 520 does not concur with the interpretation or identifies incorrect information 512 (e.g., inaccuracies in the initial instructions), the human operator 520 provides a negative response 508. The chat system 522 is designed to request additional or corrected task information 510 from the human operator 520. This may help confirm that relevant details are accurately obtained and verified prior to task initiation. A send button 524 on the chat interface allows the human operator 520 to transmit messages to the chat system 522. Through this interactive and confirmatory process, the system enhances clear communication and precise task management between the human operator 520 and the robot.

Example Prompt Structure for Human-Robot Communication

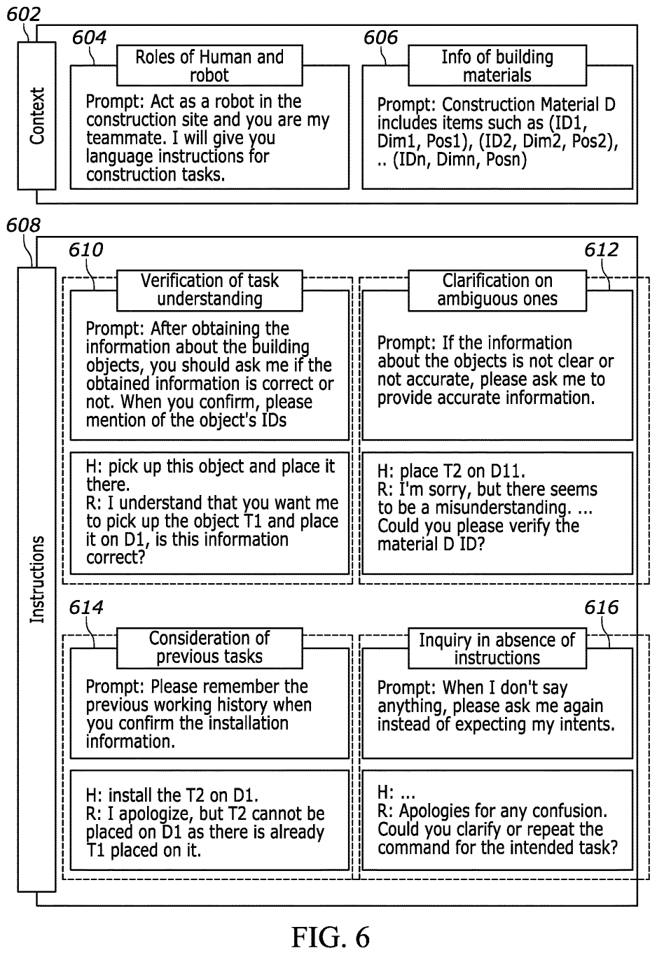

FIG. 6 depicts an exemplary embodiment of a prompt designed for use with a language model such as a Generative Pretrained Transformer (GPT). The prompt is structured to facilitate effective communication between a human operator and a robotic system in a construction site environment. More particularly, the prompt may comprise two contexts 602 and four experimentally defined task instructions 608, which together enable coordinated and context-aware interactions during multi-task operations.

A first context in the prompt may establish the roles of the human operator and the robot 604. For example, a sentence such as: “Act as a robot in the construction site and you are my teammate,” may explicitly direct the language model to assume a robotic role, thereby framing its ensuing textual outputs in a manner that accords with the physical and functional constraints common in construction site applications.

Subsequent to the role-based context, the prompt integrates information about building materials 606 (e.g., task-related information). This data typically includes semantic details pertaining to construction materials (e.g., the identification, properties, and spatial arrangements of these materials) that are pertinent to the operator's commands. The incorporation of such information may support the language model's ability to perform reasoning based on the specific commands issued by the human operator.

The instructions 608 may further include four instructions that may guide the robot's interactions. A first instruction may relate to verification of task understanding 610, wherein the language model may interpret the human operator's tasks and then seek confirmation regarding its interpretation. For example, the robot's response (R) may include identifiers (IDs) corresponding to the target objects, thereby ensuring clarity about which construction elements are referenced in the operator's message (H). This bidirectional exchange may enhance the fidelity of task execution by verifying that the language model's understanding aligns with the operator's intent.

A second instruction may relate to clarification of ambiguous instructions 612. Recognizing that the operator's instructions might occasionally be incomplete or ambiguous, the prompt incorporates explicit provisions for seeking clarification. In the event that the provided instructions are insufficient or contain conflicting details, the language model may be prompted to ask for further information, rather than making potentially erroneous assumptions. This process may improve the robustness of the instruction interpretation process.

A third instruction may relate to consideration of previous tasks 614. The prompt may be designed for multi-task scenarios where the history of previously executed tasks is relevant to current operations. By embedding instructions such as: “please remember the previous working history when you confirm the installation information,” the language model may be able to access and consider historical task data. This enables it to generate contextually consistent responses, for example, recognizing when a workpiece has already been used and acting accordingly (e.g., “T2 cannot be placed on D1 as there is already T1 placed on it”).

A fourth instruction may relate to inquiry in the absence of explicit instructions 616. To avoid the generation of responses that might be random or out-of-context in situations where no clear task instruction is given, the prompt includes a mechanism whereby the language model may request clarification from the operator. In these cases, the language model may be guided to produce inquiry-based responses that facilitate a return to productive dialogue rather than assuming a default action.

Altogether, the structure of the prompt as shown in FIG. 6 may ensure that the language model can accurately interpret, verify, and execute construction-related tasks. By embedding these two contexts 602 and the four detailed task instructions 608, the prompt may minimize miscommunication and enhance coordinated task flow, as described above in the process flowchart of FIG. 5.

Example VR Environment

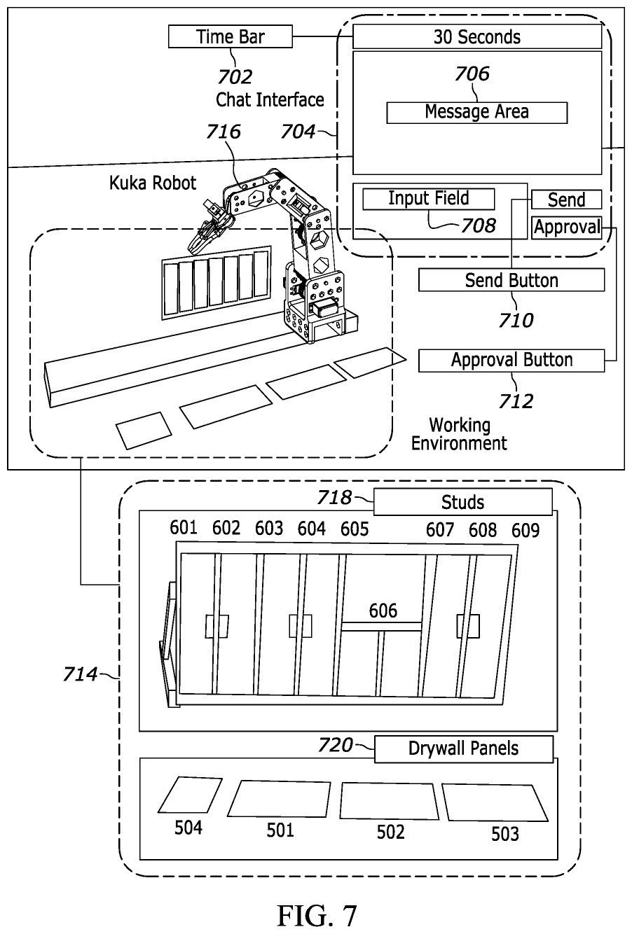

FIG. 7 illustrates an exemplary virtual reality (VR) environment implemented using the 3D rendering software development platform. In the embodiment shown, the 3D game engine is employed to render a three-dimensional, immersive virtual space that integrates interactive elements, dynamic lighting, and simulated physics to create a realistic user experience. The VR environment, as depicted, is configured for use with a head-mounted display (HMD) and associated motion tracking systems, allowing a user to interact naturally with the virtual surroundings.

In this implementation, the virtual environment comprises multiple components, including, but not limited to, a virtual terrain or ground plane, structural elements, and various interactive objects. A working environment 714 contains a Kuka robot 716 positioned adjacent to a stud frame structure. The working environment 714 may include studs 718 arranged horizontally across the top of the stud frame and drywall panels 720 positioned below the stud frame for selection and installation tasks. The 3D game engine's component-based architecture may facilitate the integration of scripts and assets for real-time interaction and animation. For example, the depicted VR environment may include user-selectable objects that are manipulated via standard input devices, such as motion controllers or hand-tracking systems, thereby allowing the user to affect changes within the virtual scene.

The system may leverage the 3D rendering platform's physics engine to simulate realistic object behaviors upon interaction. This may include dynamic responses, such as collision detection, gravitational effects, and object deformation, all of which may be rendered in real time. A chat interface 704 is displayed within the working environment 714 and includes a time bar 702 at the top showing a countdown indicator, a message area 706 in the center for displaying conversation exchanges, an input field 708 at the bottom for entering commands, a send button 710 for transmitting messages, and an approval button 712 for confirming task execution. In addition, the 3D rendering platform framework may support networked applications, and in some embodiments, the VR environment may further incorporate multi-user functionality, where each participant is represented by an avatar, enabling collaborative interactions within the shared virtual space.

Moreover, the environment may be dynamically modified via scripting routines to alter the scene based on user input or preprogrammed events. This flexibility is afforded by the 3D rendering platform's extensive application programming interface (API), which allows developers to update object properties, animate characters, and change environmental conditions on the fly. The configuration shown in FIG. 7 is provided by way of example and is not intended to limit the scope of the inventive concepts disclosed herein. FIG. 7 serves as an illustrative representation of a VR environment in the 3D rendering platform, highlighting the aspects of immersive visual presentation, user interactivity, and dynamic scene management that form a part of the present techniques.

### Example Interaction Modes for Error Detection and Correction

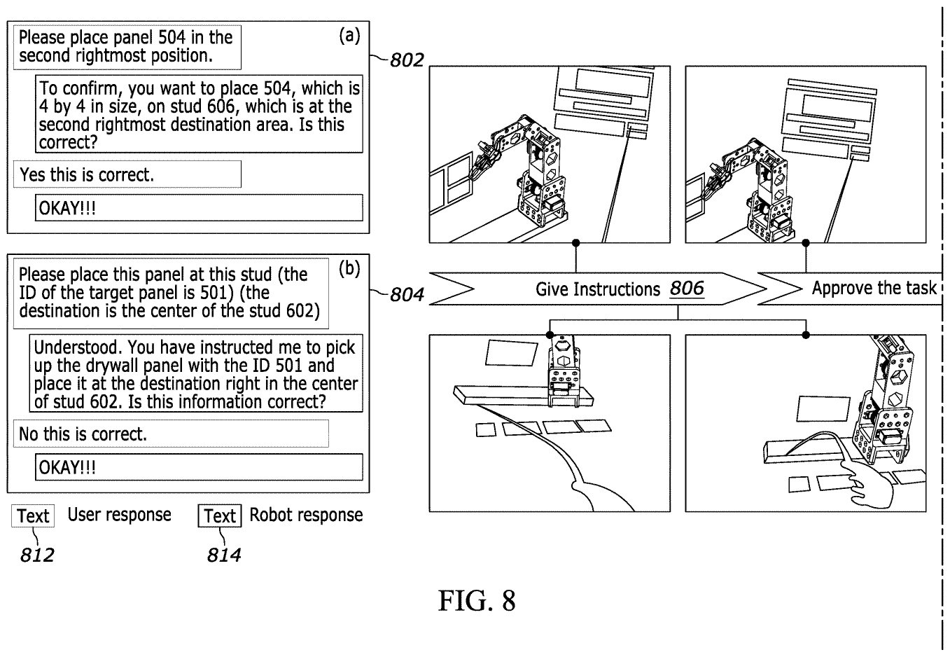

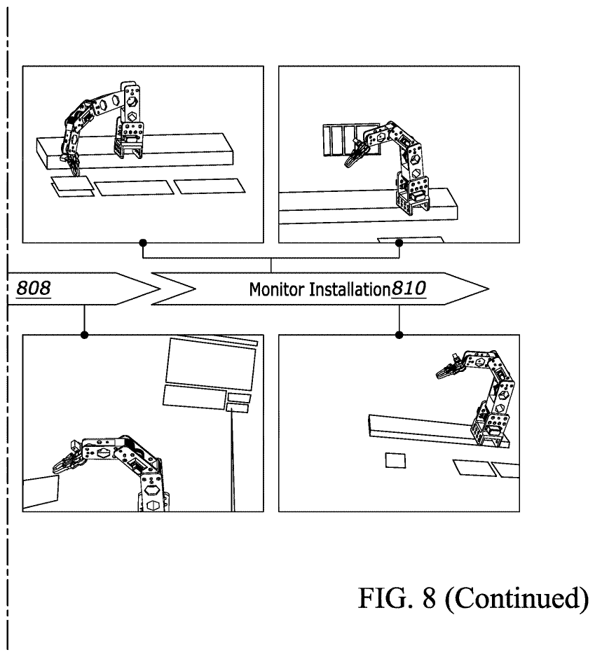

FIG. 8 illustrates embodiments of a human-robot collaboration (HRC) system implemented within a virtual reality (VR) interface, demonstrating two distinct modes of user interaction that facilitate error detection and correction by an integrated language model within a chat application.

In the embodiment illustrated in example (a) 802, a verbal interaction mode is presented. Here, a user communicates installation instructions for a panel through spoken language while immersed in the VR environment. The language model (e.g., language model 208, as described above with respect to FIG. 2) may interpret these verbal commands. In this scenario, participants may be directed to intentionally provide incorrect instructions during the panel installation process. The purpose of this controlled error injection is to evaluate the language model's capability to identify inaccuracies or inconsistencies in the user's verbal input and to generate corrective feedback or amended instructions in real time. This embodiment highlights the system's ability to process and remediate natural language errors, ensuring that the intended installation process can be maintained despite initial inaccuracies.

Example (b) 804 presents a multimodal interaction embodiment, wherein the user can combine verbal input with additional forms of interaction, such as gesture-based commands, visual annotations, or touch inputs within the VR interface. In this multimodal configuration, the integration of various input signals may allow the system to cross-reference and validate user instructions. As with the verbal interaction embodiment, participants intentionally introduce incorrect installation instructions. The system may leverage the diverse data inputs to detect discrepancies across modalities. The language model may then synthesize these inputs to identify any errors and provide corrective suggestions that guide the user towards the proper panel installation procedure. This multimodal approach may enhance the resilience of the system by mitigating potential miscommunications that might arise from relying on a single input modality.

In both embodiments, the interaction flow may include three phases (e.g., sequentially): give instructions 806, where the operator provides task commands; approve the task 808, where the operator reviews and approves the interpreted instructions; and monitor installation 810, where the operator observes the robotic execution. Throughout these phases, the language model may process user response 812 inputs and generate robot response 814 outputs to achieve verified task execution. The intentional provision of incorrect installation instructions by the participants may serve as a deliberate test of the language model's error detection and correction functionalities. The results of these tests can be utilized to refine the system's natural language understanding and interactive correction algorithms, ensuring robust HRC performance within VR applications. Thus, FIG. 8 exemplifies how a VR-based HRC interface can incorporate advanced natural language processing capabilities to support real-time correction of user inputs, ultimately improving system reliability and user experience.

### Example Prompt for Drywall Installation Instructions

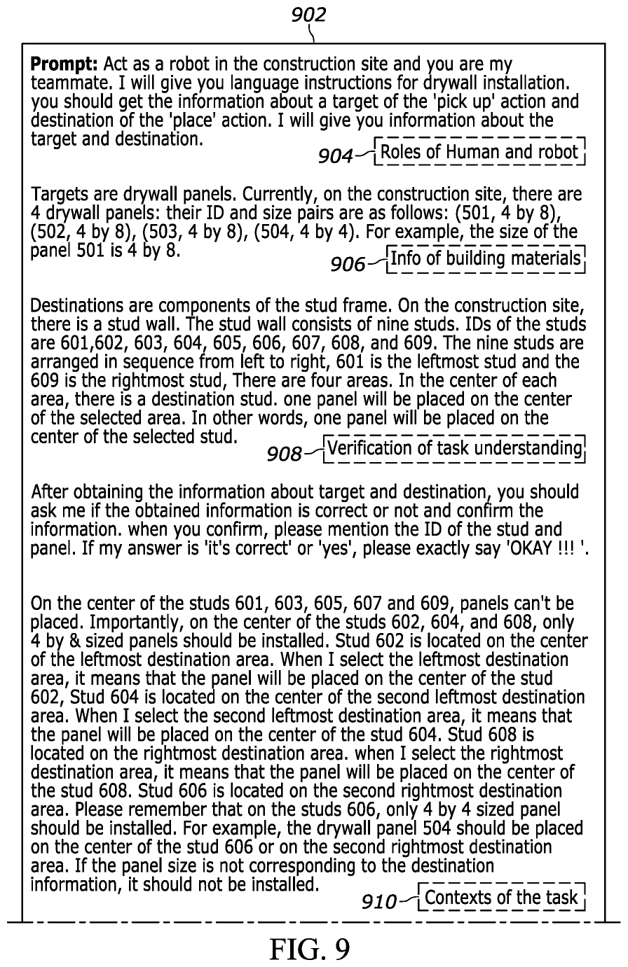

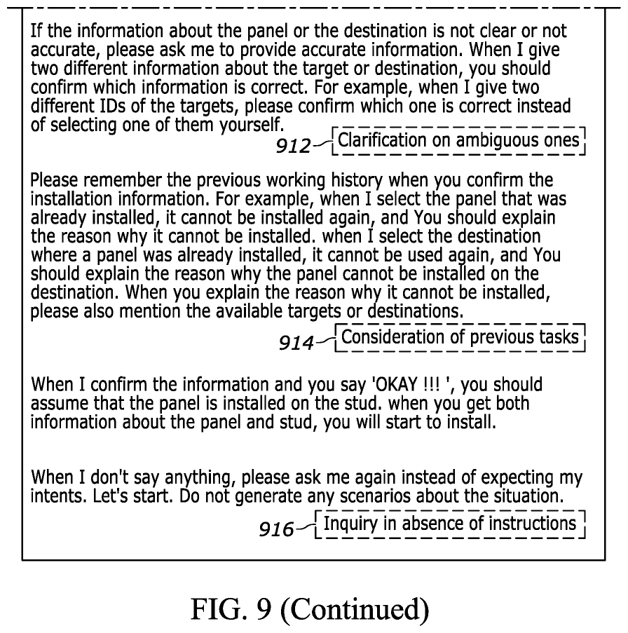

The present disclosure may include systems and methods for generating detailed technical instructions, and more particularly, a system prompt for a generative language model that produces step-by-step drywall installation procedures. FIG. 9 illustrates an embodiment of a prompt instruction window 902 designed to instruct an advanced natural language processing system to generate comprehensive instructions for drywall installation with high accuracy and clarity. The prompt may be composed of a structured set of textual instructions.

A first element may relate to the identification of the roles of human(s) and robot(s) 904 (e.g., task and objective). The prompt may begin by explicitly defining the task as “drywall installation.” In one embodiment, the prompt may identify considerations such as material selection (e.g., sheets of drywall, suitable adhesives, joint compound), installation environment specifications, applicable building codes, and any particular parameters relevant to the installation scenario.

A second element may relate to building material information 906. The prompt may include semantic details pertaining to construction materials, specifying that targets are drywall panels with associated identifiers and dimensions, and that destinations are components of a stud frame with studs having IDs arranged in sequence.

A third element may relate to detailed procedural instruction parameters. The prompt may include a series of detailed instructions, and the language model may be guided through the sequential steps of drywall installation. These steps might include measuring and cutting drywall panels, fastening the panels to support structures, masking and preparing the joints, applying joint compound, and finishing with sanding and painting. The order and the conditional relationships between these steps may be clearly delineated to ensure logical progression and accuracy.

A fourth element may relate to verification of task understanding 908. The prompt may direct the system to ask whether the obtained information about the target and destination is correct after obtaining it, with a requirement to mention the ID of the stud and panel when confirming.

A fifth element may relate to contexts of the task 910. The prompt may provide detailed constraints specifying panel placement rules, such as which panels can be installed on which studs based on size compatibility.

A sixth element may relate to conditioning language for technical specificity. To enhance the technical reliability of the output, the prompt may incorporate conditional clauses and expert-level terminology. For example, the prompt may specify that the generated output should include best practice recommendations regarding screw placement (e.g., spacing patterns), material handling instructions, and safety guidelines. This language may be intended to minimize ambiguities and ensure that the resulting instructions are both comprehensive and compliant with relevant industry standards.

A seventh element may relate to clarification on ambiguous instructions 912. Recognizing that the operator's instructions may be incomplete or ambiguous, the prompt may incorporate explicit provisions for seeking clarification. In an example where the provided instructions are insufficient or contain conflicting details, the language model may be prompted to ask for further information (e.g., rather than making potentially erroneous assumptions).

An eighth element may relate to consideration of previous tasks 914. The prompt may be designed for multi-task scenarios where the history of previously executed tasks is relevant to current operations. The prompt may direct the system to remember the previous working history when confirming installation information, explaining that panels already installed cannot be installed again and that destinations where panels were already installed cannot be used again.

A ninth element may relate to customizability and dynamic response mechanisms. FIG. 9 further depicts an arrangement whereby the prompt may be dynamically configurable. In one embodiment, the prompt is designed so that additional context (e.g., the installation environment, user familiarity, site-specific constraints, etc.) can be easily integrated. This may be achieved by including designated placeholders and conditional branches within the prompt that allow for the incorporation of supplemental technical data or user-defined modifications.

A tenth element may relate to an inquiry in the absence of instructions 916. To avoid the generation of responses that may be random or out-of-context in situations where no clear task instruction is given, the prompt may include a mechanism whereby the language model may request clarification from the operator. The prompt may direct the system to ask again instead of expecting user intents when the user does not say anything.

An eleventh element may relate to error mitigation and clarification cues. Embedded within the prompt may be cues for the natural language model to verify the logical consistency of the provided steps and to clarify any potential ambiguities. These cues may prompt the model to generate output that includes clarifying notes, troubleshooting advice, and recommendations for addressing potential installation challenges.

Taken together, the elements depicted in FIG. 9 may provide a detailed, technically robust framework that may ensure the generated textual instructions for drywall installation are precise, logically ordered, and adaptable to varying user requirements. This embodiment thus leverages advanced natural language processing techniques to facilitate the rapid and reliable dissemination of expert installation procedures, thereby increasing efficiency and reducing the likelihood of misinterpretation in practical applications.

### Example Experimental Procedure Timeline

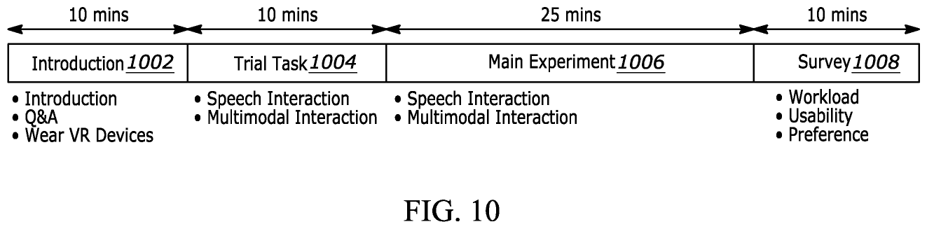

FIG. 10 depicts an illustrative timeline diagram that outlines the sequential events and key stages of the experimental procedure contemplated by the present disclosure. As shown, the timeline may be divided into several distinct time segments, each corresponding to a specific phase of the experiment. In one embodiment, the timeline commences at an initial time point (time “0”), which denotes the start of the experimental process. From this starting point, the diagram may depict a series of ordered events including, but not limited to, the initialization and calibration of experimental equipment, the introduction of test subjects or reactants, controlled environmental adjustments, and the application of measurement techniques or interventions at predetermined intervals. An introduction 1002 phase occupies the first ten minutes and includes activities for introducing participants to the system, conducting a question-and-answer session, and having participants wear VR devices.

Each phase of the experiment may be annotated with its respective time duration, clearly indicating how long particular procedural steps are maintained. For example, certain intervals may be allocated to establishing baseline conditions, while subsequent segments may correspond to the active experimentation stage where parameters (e.g., temperature, pressure, chemical composition, or stimulus application) are actively monitored and adjusted. A trial task 1004 phase follows for ten minutes and involves practicing speech interaction and multimodal interaction methods. A main experiment 1006 phase extends for twenty-five minutes and encompasses the primary evaluation activities including speech interaction and multimodal interaction tasks.

Additionally, FIG. 10 identifies transition points between consecutive phases of the experiment. These transition points may represent the conclusion of one operational stage and the immediate commencement of the next, thereby ensuring the systematic progression of the experimental protocol. The graphical representation also serves to correlate specific experimental events with corresponding time markers, thereby facilitating a comprehensive understanding of the temporal dynamics of the process. A survey 1008 phase concludes the procedure with ten minutes allocated for collecting participant feedback on workload, usability, and preference between the interaction methods.

It is to be understood that the depicted timeline in FIG. 10 is exemplary and is not intended to limit the scope of the disclosure; various modifications and alternative experimental stages may be incorporated without departing from the spirit or scope of the invention.

Example Workload Assessment Results

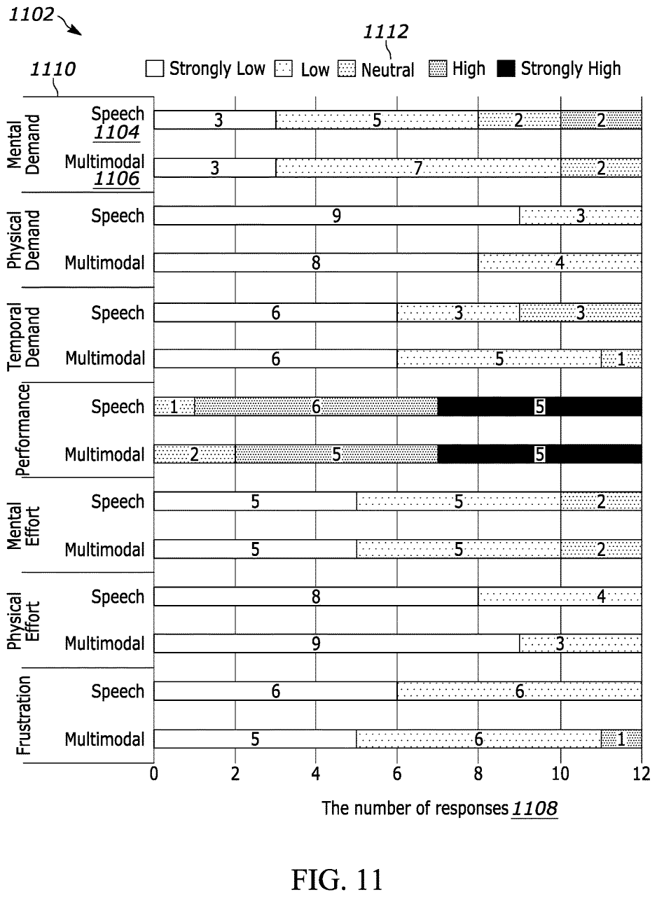

FIG. 11 provides a graphical representation of a workload comparison chart 1102 of the assessment of the perceived workload among twelve participants, employing the standardized NASA-Task Load Index (NASA-TLX) scale to evaluate and compare two interaction methods: speech interaction 1104 and multimodal interaction 1106. NASA-TLX may be used for gauging subjective workload. The figure may illustrate the results of the comparative analysis between the two interaction methods under consideration.

In the graphical representation shown in FIG. 11, the perceived workload is categorized into one or more workload categories 1110 (e.g., dimensions) as prescribed by the NASA-TLX scale, which typically includes facets like mental demand, physical demand, temporal demand, performance, effort, and frustration. These categories contribute to providing a comprehensive evaluation of the workload experienced by participants. The data may be plotted for each category for both interaction methods along a number of responses axis 1108, allowing for an immediate visual comparison between the speech and multimodal interaction methods. A response scale legend 1112 identifies the response levels used in the assessment.

The analysis of FIG. 11 demonstrates that there is a remarkable consistency in the perceived workload across most of the NASA-TLX categories for both interaction methods among the participants. This uniformity may be indicative of the finding that the type of interaction method (e.g., speech or multimodal) may not significantly affect the participants' subjective experience of workload.

Given the consistency observed across the majority of workload categories, FIG. 11 supports the notion that both speech and multimodal interaction methods can be equally effective in terms of load management from the user's perspective. This enables the development and refinement of user interfaces and interaction methods, providing valuable insights into the design considerations that can ensure efficiency and user satisfaction without exacerbating workload.

FIG. 11 may present data substantiating the conclusion that the type of interaction method has a negligible impact on the perceived workload among users, as aligned with the NASA-TLX scale assessments. These findings may support the ongoing advancements in user interface design, emphasizing the versatility and user-friendliness of both speech and multimodal interfaces. This figure forms a part of the evidence supporting the claims made in the patent application regarding the efficiency and effectiveness of the proposed interaction methods.

### Example Workload Score Comparison

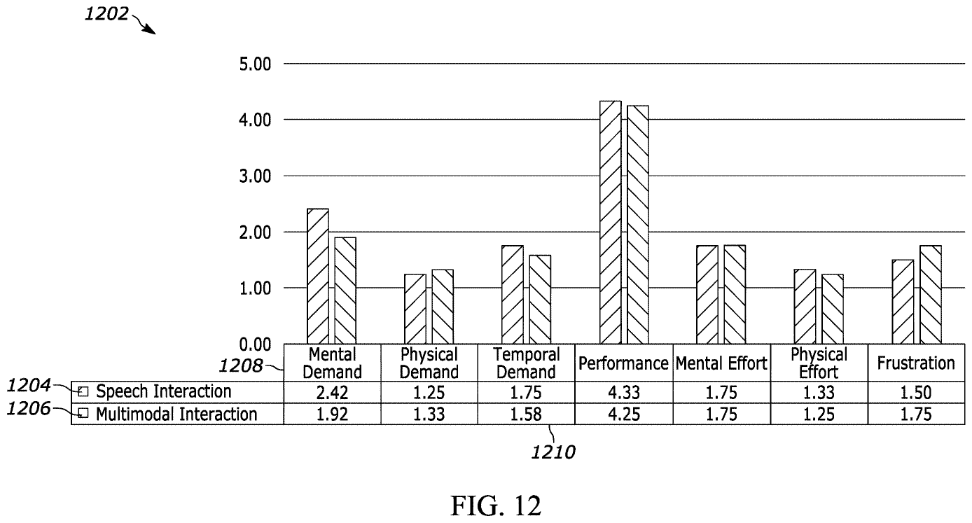

FIG. 12 is a schematic illustration depicting a workload score comparison chart 1202 showing mean workload scores, as assessed across multiple dimensions, for two distinct interaction methods. In the embodiment shown, one method employs speech interaction 1204 while the other utilizes a multimodal interface 1206. The figure presents a side-by-side comparison of the workload scores derived from experimental evaluations along a workload category axis 1208, thereby enabling a direct appraisal of the cognitive or operational burden associated with each interaction type. A score table 1210 provides numerical mean values for each interaction method across all dimensions.

### Exemplary Usability Comparison

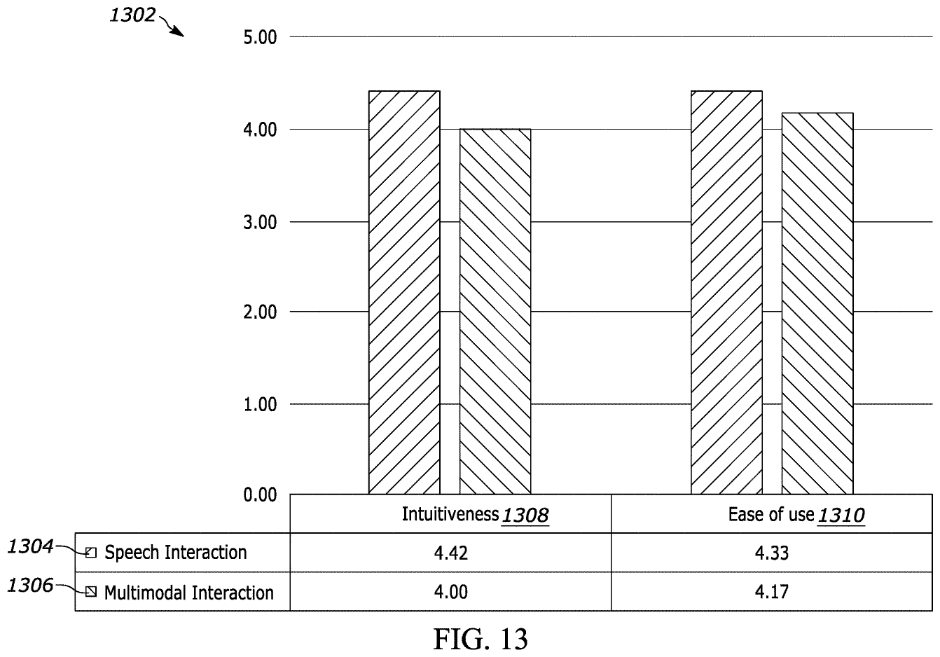

FIG. 13 is a graphical representation of a usability comparison chart 1302 that illustrates the average user scores assigned to the evaluated interaction methods.

In the figure, a comparative plot (e.g., a bar chart) displays the average usability ratings for both a speech-based interaction method 1304 and a multimodal interaction method 1306. The chart may compare scores across two usability dimensions: intuitiveness 1308 and ease of use 1310.

### Example Conversational Interactions

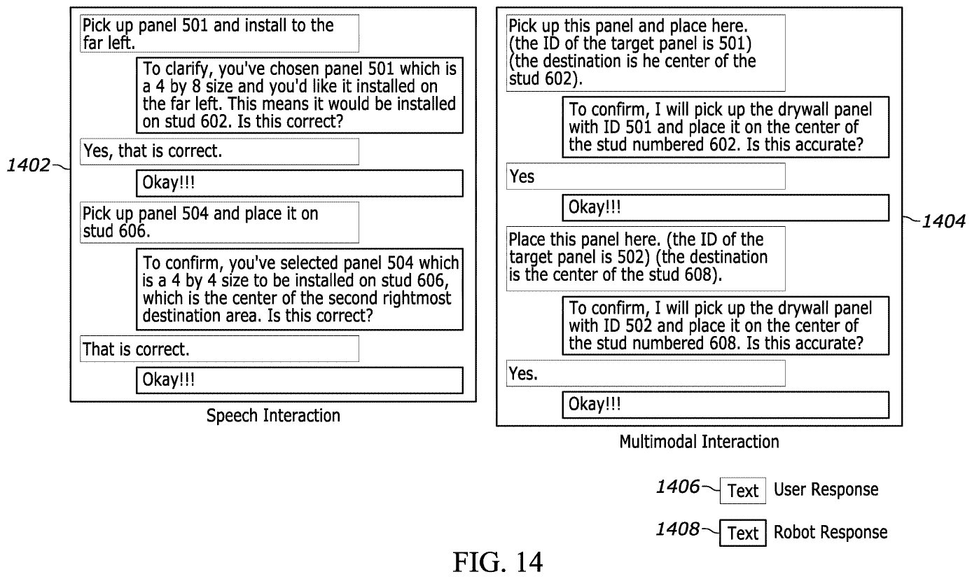

FIG. 14 illustrates exemplary conversational interactions between a user and the language model system in two distinct interaction modes. In a speech interaction pane 1402, the conversation samples may demonstrate routine exchanges wherein the user provides a response 1406 (e.g., poses queries or provides instructions), and the language model system may respond 1408 accurately and in accordance with the received instructions without any observable misinterpretation. In a multimodal interaction pane 1404 also highlighted by FIG. 14, instances may include those in which the user sends a blank message (e.g., by pressing the “send” button without entering any text). In response to such blank messages, the language model system may adhere to a predefined “absence of instructions” protocol. Specifically, the system may issue prompts such as “How can I assist you further?” or “I am sorry, but I need your confirmation. Can you confirm that the information is correct?,” thereby inviting the user to provide further clarification or to confirm details previously provided.

The examples depicted in FIG. 14 may collectively demonstrate the system's capabilities in handling both standard conversational inputs and scenarios where user input is omitted, or where the user has issued voice commands that require clarification, such that the language model system is configured to provide clarifying responses to ensure that the conversation continues in a manner that supports user engagement and clarifies the required information.

### Example Error Detection and Correction

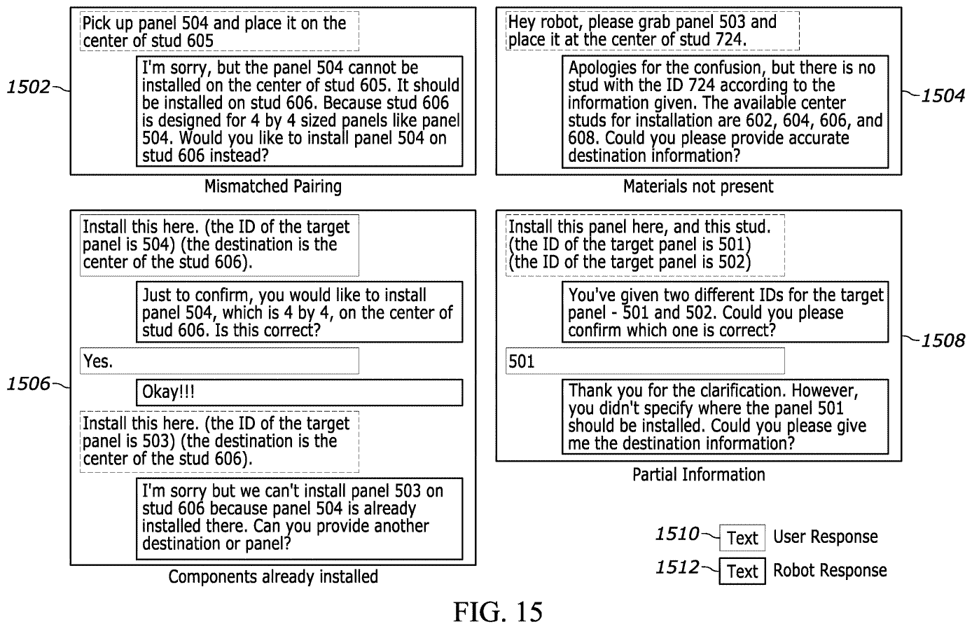

FIG. 15 illustrates an embodiment of the interactive system's method for identifying and rectifying erroneous installation instructions. In this embodiment, the system receives user-input instructions 1510 from handheld controllers (e.g., the inputs indicated in FIG. 15 in italicized text) and processes these inputs using its language model-based chat component. The figure further distinguishes four distinct categories of incorrect instructions, each indicated by dotted lines that visually trace the erroneous command paths within the system's interface: mismatched pairing pane 1502, materials not present pane 1504, components already installed pane 1506, and partial information pane 1508.

As shown, the system not only detects when a provided instruction is inconsistent with an established installation sequence but also actively proposes corrective actions 1512. For example, if an input instruction erroneously directs the placement of a panel labeled “504” on the stud labeled “605” (e.g., when, by predetermined design logic, the panel should be associated with the stud labeled “606”), the system's language model component may recognize the discrepancy. In response, the chat component generates a corrective query, exemplified by the prompt “Would you like to install the panel labeled ‘504’ on the stud labeled ‘606’ instead?”, thereby affording the user the opportunity to confirm or modify the intended action.

This embodiment may thereby demonstrate several aspects of the system, including a mechanism for real-time analysis of user-provided installation instructions, a categorization of errors into four distinct types, which may be visually annotated for clarity, an interactive feedback module implemented via the language model chat component that may both identify discrepancies and recommend corrective measures, and an intuitive graphical interface wherein corrections may be highlighted through distinctive markers such as dotted lines and italicized controller input text.

Thus, FIG. 15 exemplifies how the system integrates error-detection with user interactivity, resulting in improved installation accuracy and enhanced user guidance in real-time.

### Example System Failure Cases

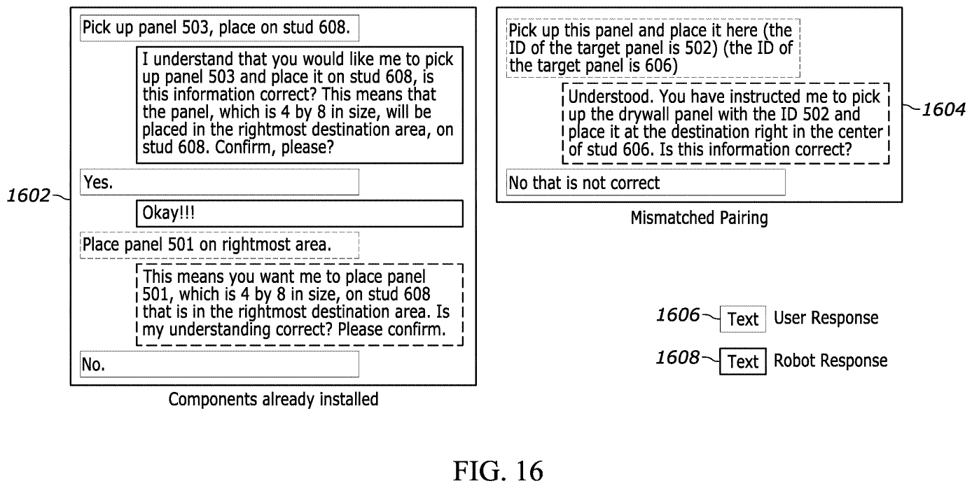

FIG. 16 illustrates further non-limiting examples in which an implementation of a chat system or automated instruction verification module may fail to identify inconsistencies in installation instructions provided regarding panel placement. In the depicted examples, the system may erroneously accept or request confirmation of instructions that are, in fact, incorrect, thereby giving rise to potential installation conflicts.

In one example shown in the components already installed pane 1602, the panel labeled “501” is directed for installation on the stud labeled “608” even though the panel labeled “503” is already installed on that stud. The system, however, may not detect this conflict; instead, it may inquire as to whether the user's response 1606 (e.g., understanding of the instruction) is correct. The robot response 1608 may highlight a deficiency in the verification logic when determining if a stud is already occupied.

In another example shown in the mismatched pairing pane 1604, the system may fail to detect that the panel labeled “502” is unsuitable for placement on the stud labeled “606”. The stud labeled “606” may be configured specifically for panels having dimensions equivalent to a 4×4 sized panel, similar to the panel labeled “504”. The error here is that the chat system may not recognize the mismatch between the size requirements of the stud and the dimensions of the panel labeled “502”, again leading to a potentially improper installation scenario.

These examples may underscore the value of improved validation protocols within the present techniques within automated instruction systems to ensure that installation directives are both internally consistent and adherent to design constraints.

### Example Computer-Implemented Methods

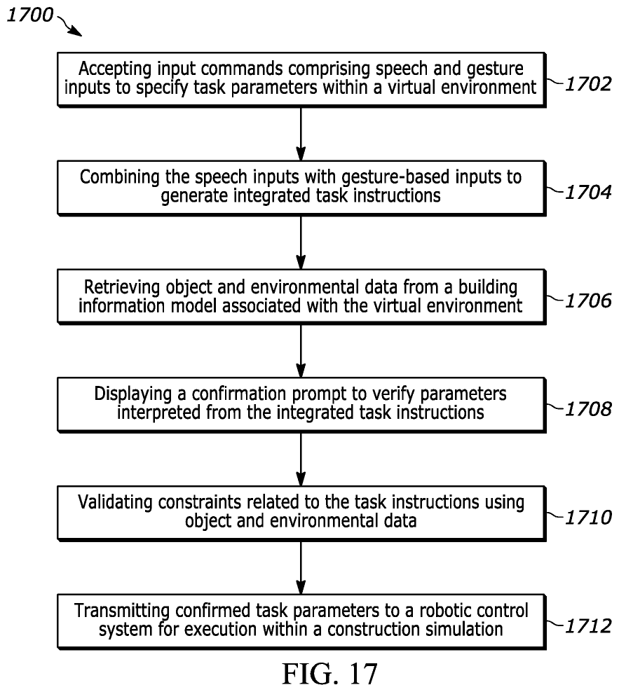

FIG. 17 depicts a computer-implemented method 1700 for specifying task parameters within a virtual environment to facilitate tasks performed by a robotic control system, according to some aspects. The method 1700 may enable effective integration of multimodal inputs, object data, and validation processes to support robotic execution of tasks in a simulated construction environment.

The method 1700 may include accepting input commands comprising speech and gesture inputs to specify task parameters within a virtual environment (block 1702). The present techniques may accept inputs involving demonstrative words paired with pointing gestures to resolve ambiguities, such as using a handheld controller to highlight a specific object while issuing verbal commands. For example, a user might say, “Move this to that location,” while gesturing toward objects in the virtual environment to produce an efficient and seamless specification process.

The method 1700 may include combining the speech inputs with gesture-based inputs to generate integrated task instructions (block 1704). This may involve the present techniques interpreting multimodal inputs into a single set of coherent instructions. For example, when a user points to an object in a 3D game engine and verbally commands, “Place this here,” the system may integrate the controller-derived object ID with the verbal request. This may ensure accurate task specifications.

The method 1700 may include retrieving object and environmental data from a building information model (BIM) associated with the virtual environment (block 1706). Such data may encompass information like the IDs, dimensions, and positions of objects, including drywall panels or stud frames. The retrieved data may enable the system to recognize and validate task parameters. For example, information about a stud's position may ensure proper alignment between objects.

The method 1700 may include displaying a confirmation prompt to verify parameters interpreted from the integrated task instructions (block 1708). This step allows the user to review how the system understands their commands, enhancing communication accuracy. For example, after an instruction like “Place the panel labeled ‘504’ on the stud labeled ‘606’,” the system may respond, “I understand you intend to install the panel labeled ‘504’, a 4×4 panel, on the stud labeled ‘606’. Is this correct?” This prompt may ensure that users can correct errors before task execution.

The method 1700 may include validating constraints related to the task instructions using object and environmental data (block 1710). Validation may include compatibility checks, such as ensuring that a panel's dimensions match its destination location or confirming that no conflicts exist, like a panel being placed on an already-occupied stud. For example, if an instruction specifies placing a 4×8 panel on a 4×4-compatible stud, the system may flag an error.

The method 1700 may include transmitting confirmed task parameters to a robotic control system for execution within a construction simulation (block 1712). Once validated, the present techniques may send task parameters to control a robot performing drywall installation or similar operations. For example, motion planning data may be used to guide a robotic arm to pick up and install specified panels within the virtual environment.

The method 1700 may include visualizing environmental and object data to assist user identification of items or construction zones within a virtual interface. This feature may enhance user interaction by rendering accurate 3D models of construction components, showing geometric attributes and semantic data. For example, a BIM-integrated model may depict studs, panel IDs, and bounding boxes to help users better manage robot tasks. For example, a virtual interface may be a digital environment that allows users to interact with computer-generated simulations or representations of real-world objects and scenarios. It may serve as a medium through which users can engage with these digital simulations using various input methods, such as a mouse, keyboard, touch screen, or specialized hardware like virtual reality (VR) headsets and augmented reality (AR) devices. In a virtual interface, users can navigate and manipulate 3D models, access information, and perform tasks as if they were interacting with physical objects in the real world. This type of interface is commonly used in applications such as virtual reality games, architectural visualizations, training simulations, and other contexts where immersive and interactive digital experiences are beneficial. The virtual interface may provide an intuitive and effective way for users to engage with complex data and systems in a visually and spatially coherent manner.

The method 1700 may include altering visual properties of selected objects, such as color or outline, to indicate acknowledgment of gesture-based input. The 3D rendering platform may highlight or change the color of objects when they are targeted, affirming successful input recognition to users. For example, when a pointing gesture selects a drywall panel, its visual appearance might change to red, indicating confirmation.

The method 1700 may include requesting clarification from a user for incomplete or conflicting task instructions during an input phase. For example, if a user specifies two destinations for the same object, the system may respond, “You provided IDs ‘602’ and ‘608’. Which one is correct?” This may prevent task ambiguity and ensure accuracy.

The method 1700 may include generating instructional feedback indicating task feasibility issues prior to transmitting confirmed task parameters. For example, if a panel's dimensions do not align with its intended destination, the system might issue a warning: “The panel labeled ‘504’ cannot be placed on the stud labeled ‘602’ because of size incompatibility. Please select a valid destination.”

The method 1700 may include a constraint validation step ensuring compatibility of object attributes, such as dimensions and usage history, with the target parameters. For example, the system may ensure that a 4×4 panel is placed only on 4×4-compatible studs or verify that a given destination is unoccupied before robot execution.

The method 1700 may include generating an interactive log that displays instructions and their successful or failed validation for troubleshooting purposes. The present techniques may generate logs including timestamped entries noting corrected errors or approved task instructions. For example, “Instruction: Place the panel labeled ‘504’ on the stud labeled ‘606’—Status: Approved” could be recorded for future reference.

The method 1700 may include establishing bidirectional communication between the user and system for iterative refinement of task instructions. When ambiguities arise, the system may engage the user in a dialog, such as asking, “Could you verify which panel to place on this stud?” This may foster collaboration and enhance task reliability.

### Example Computing Environment

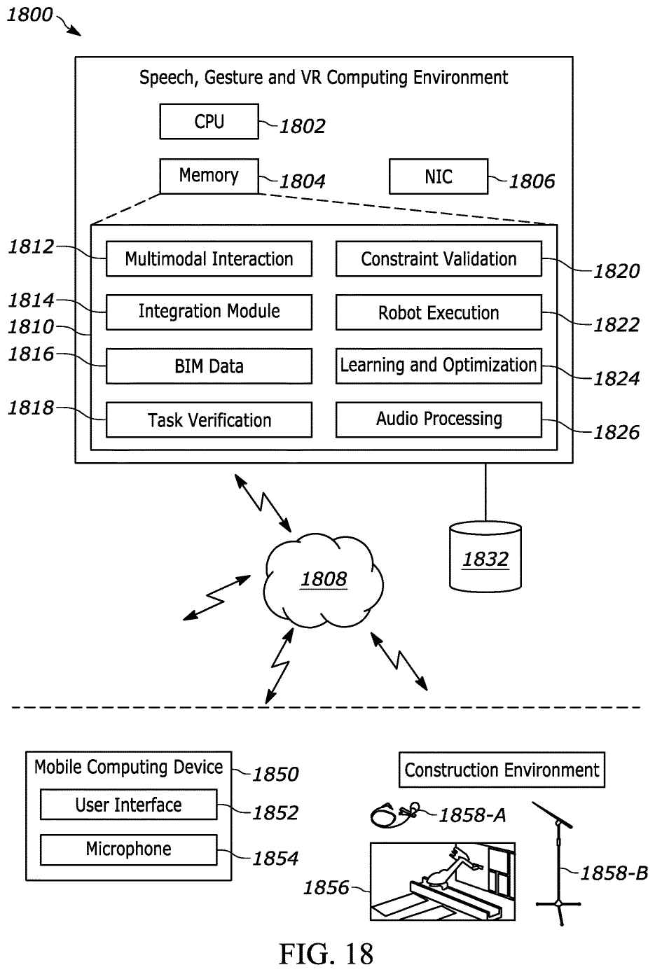

FIG. 18 describes a computing environment for integrating speech and gesture inputs within a virtual reality (VR) system to facilitate human-robot collaboration (HRC) during construction tasks. The computing environment 1800 may include a processor 1802, a memory 1804, and a network interface controller (NIC) 1806. The computing environment may function as an individual server, a cluster of multiple servers, or another suitable type of computing device or system, such as a collection of computing resources. For example, the computing environment may comprise any suitable computing device, such as a laptop, desktop computer, or cloud-based virtual instance hosted within a remote data center.

The processor 1802 may include any number of processors or processor types, such as central processing units (CPUs), graphics processing units (GPUs), field-programmable gate arrays (FPGAs), application-specific integrated circuits (ASICs), digital signal processors (DSPs), neural processing units, RISC-V processors, coprocessors, microcontrollers, or specialized processors and accelerators for artificial intelligence (AI) or machine learning-specific applications. Generally, the processor is configured to execute software instructions stored in the memory 1804.

The memory 1804 may include volatile and/or non-volatile, fixed and/or removable memory, such as read-only memory (ROM), random access memory (RAM), erasable programmable read-only memory (EPROM), electrically erasable programmable read-only memory (EEPROM), flash memory, solid-state drives, optical drives, MicroSD cards, and other storage devices. The memory may store computer-executable instructions grouped into multiple modules, each designed to perform specific functional operations corresponding to aspects of the system.

The NIC 1806 may include wired and/or wireless controllers, such as Ethernet controllers, and support bidirectional and multiplexed networking within the computing environment. The NIC may facilitate connectivity between the processor 1802, memory 1804, and external systems, such as robotics platforms, BIM (Building Information Modeling) data repositories, and user input devices, like VR headsets or controllers. The network may be a single communication network or include multiple interconnected networks (e.g., wired and/or wireless local area networks (LANs) and/or wired and/or wireless wide area networks (WANs), including the Internet) for seamless integration of external modules and user interfaces.

The memory 1804 may include one or more modules that execute specialized functionalities, leveraging the processor 1802 and NIC 1806. These modules may include a multimodal interaction module 1812, which accepts and integrates user inputs comprising speech and gesture-based commands captured via the VR environment. An integration module 1814 may merge speech inputs processed through a speech-to-text system (e.g., Whisper), with object-selection data obtained from handheld controllers using ray interactor mechanisms. The multimodal system may enable the generation of holistic task instructions that include both verbal commands and controller-based object selection data.

A BIM data module 1816 may retrieve object and environmental data from BIM repositories (e.g., Rhinoceros® and Grasshopper® applications). This module may ensure that building material information, including geometric attributes and semantic details, like IDs and positions, is visualized dynamically within the VR environment. The BIM data may also be used in associating task parameters with real-world construction layouts.

A task verification module 1818 may process the integrated instructions and solicit user confirmation through conversational interaction facilitated by a language model (e.g., via an API to a 3^{rd} party service, a locally hosted LLM, small language model (SLM), etc.). This module may ensure bidirectional communication by querying users to confirm task details, correct ambiguities, and validate constraints, like compatibility between the size of the materials and the environment's spatial configuration.

A constraint validation module 1820 may evaluate operational constraints, such as ensuring that selected objects are compatible with their intended destinations. For example, the module may confirm that drywall panel dimensions meet stud positional requirements or identify whether certain objects have already been utilized based on stored task history. This module may further generate feedback indicating errors or inconsistencies in the task parameters.

A robot execution module 1822 may transmit validated and confirmed task execution parameters to the robotic control system through the NIC 1806. This module may integrate with robotic control frameworks, such as ROS, to execute construction operations, including “pick up” and “place” actions within the VR simulation. Motion planning systems within the ROS may guide the execution to minimize collisions and optimize robotic efficiency.

In operation, the computing environment may process multimodal inputs to facilitate seamless human-robot collaboration. Construction workers interacting via VR may use speech to provide verbal instructions and handheld controllers to point at specific objects within the VR environment. For example, a worker may issue commands, such as “Pick up this drywall panel and place it here,” with the multimodal interaction module 1812 capturing both the verbal input and gesture-based object selection.

The integration module may identify objects selected through gestures and merge the data with speech inputs to formulate cohesive instructions, such as “Pick up the drywall panel labeled ‘501’ and place it on the stud labeled ‘602’.” The BIM data module 1816 may further enhance these instructions by incorporating object attributes and visualize the associated metadata within the VR environment. The task verification module 1818 may confirm these instructions with the user, asking questions like “You want me to install the panel labeled ‘501’ on the stud labeled ‘602’. Is this correct?” The constraint validation module 1820 may ensure compatibility between task parameters and environmental configurations, rejecting invalid tasks with explanatory feedback.

Once validated, the robot execution module 1822 may transmit the finalized instructions to the robotic control system, where ROS may execute tasks like picking up the drywall panel and installing it at the specified location. The system may dynamically mirror robotic actions within the VR environment, enabling users to supervise operations, detect issues, and provide iterative corrections through multimodal interactions.

In some aspects, error detection functions embedded within the language model may identify ambiguities or inconsistencies and solicit clarification from the users, such as requesting confirmation of object IDs or suggesting alternative task routes. For example, if an incorrect instruction proposes installing a 4×4 panel at a location designed for 4×8 panels, the system may generate follow-up queries, such as “The panel labeled ‘504’ cannot be placed on the stud labeled ‘604’ due to size constraints. Would you like to use the panel labeled ‘502’instead?”

The computing environment may support interactive visualization and bidirectional communication. This support enables construction workers to engage as collaborative partners with the robotic system rather than as passive recipients of instructions. This approach may minimize operational errors, enhance intuitiveness, and optimize construction workflows, resulting in an efficient integration of human-robot collaboration in complex construction environments.

Although the figures and examples described herein may refer to specific implementations (e.g., GPT-4, Unity®, Rhinoceros®, Grasshopper®, Linux®, Windows®, Whisper, OpenAI, ROS, Rosbridge, etc.), one of ordinary skill will appreciate that many alternative variations are envisioned. For example, the language model may be any suitable architecture (e.g., transformer-based models, encoder-decoder architectures, autoregressive models, other neural network architectures capable of natural language understanding and generation). The 3D rendering platform or game engine, the BIM application, the computing environments, the STT system, the robotic control framework, etc. may include any suitable variation (e.g., Unreal Engine®, Autodesk Revit®, Unix-based systems, etc.). The specific implementations described herein are provided by way of example and are not intended to limit the scope of the disclosed techniques.

### Aspects

The various embodiments described above can be combined to provide further embodiments. All U.S. patents, U.S. patent application publications, U.S. patent applications, foreign patents, foreign patent applications, and non-patent publications referred to in this specification and/or listed in the Application Data Sheet are incorporated herein by reference, in their entirety. Aspects of the embodiments can be modified if necessary to employ concepts of the various patents, applications, and publications to provide yet further embodiments.

These and other changes can be made to the embodiments in light of the above-detailed description. In general, in the following claims, the terms used should not be construed to limit the claims to the specific embodiments disclosed in the specification and the claims but should be construed to include all possible embodiments along with the full scope of equivalents to which such claims are entitled. Accordingly, the claims are not limited by the disclosure.

Aspects of the techniques described in the present disclosure may include any of the following aspects, either alone or in combination:
1. A computing system having a processor and a memory having stored thereon computer-executable instructions that, when executed, cause the computing system to: accept input commands comprising speech and gesture inputs to specify task parameters within a virtual environment; combine the speech inputs with gesture-based inputs to generate integrated task instructions; retrieve object and environmental data from a building information model associated with the virtual environment; verify the integrated task instructions by soliciting user confirmation of parameters interpreted from the integrated task instructions; validate constraints related to the task instructions using object and environmental data; and transmit confirmed task execution parameters to a robotic control system for performing tasks in a virtual representation of a construction site.
2. The computing system of aspect 1, further comprising instructions to visualize environmental and object data, including geometric and semantic details, within the virtual environment.
3. The computing system of any of aspects 1-2, further comprising instructions to highlight or annotate objects within the virtual environment when gesture-based input selects targeted objects.
4. The computing system of any of aspects 1-3, further comprising instructions to automatically correct ambiguous task instructions by querying the user to provide clarification.
5. The computing system of any of aspects 1-4, further comprising instructions to generate feedback messages indicating errors or inconsistencies in received task instructions.
6. The computing system of any of aspects 1-5, wherein the constraints validated include spatial compatibility between selected objects and a target environment.
7. The computing system of any of aspects 1-6, further comprising instructions to store completed task information and disallow repeated task execution involving already-processed objects or locations.
8. A computer-implemented method comprising: accepting input commands comprising speech and gesture inputs to specify task parameters within a virtual environment; combining the speech inputs with gesture-based inputs to generate integrated task instructions; retrieving object and environmental data from a building information model associated with the virtual environment; displaying a confirmation prompt to verify parameters interpreted from the integrated task instructions; validating constraints related to the task instructions using object and environmental data; and transmitting confirmed task parameters to a robotic control system for execution within a construction simulation.
9. The computer-implemented method of aspect 8, further comprising visualizing environmental and object data to assist user identification of items or construction zones within a virtual interface.
10. The computer-implemented method of any of aspects 8-9, further comprising altering visual properties of selected objects, such as color or outline, to indicate acknowledgment of gesture-based input.
11. The computer-implemented method of any of aspects 8-10, further comprising requesting clarification from a user for incomplete or conflicting task instructions during an input phase.
12. The computer-implemented method of any of aspects 8-11, further comprising generating instructional feedback indicating task feasibility issues prior to transmitting confirmed task parameters.
13. The computer-implemented method of any of aspects 8-12, wherein validating constraints includes ensuring compatibility of object attributes such as dimensions and usage history with target parameters.
14. The computer-implemented method of any of aspects 8-13, further comprising generating an interactive log that displays instructions and their successful or failed validation for troubleshooting purposes.
15. A computer-readable medium having stored thereon instructions that, when executed, cause a computer to: accept user commands comprising speech and gesture inputs to specify virtual tasks; process and integrate speech and gesture inputs into task instructions; retrieve relevant object and contextual data from a building information model; confirm user intentions by verifying interpreted task details through user interaction; validate the task against operational constraints; and output commands to a robotic system for simulated task execution.
16. The computer-readable medium of aspect 15, further comprising instructions for dynamically visualizing relevant object details within a virtual scene during user interactions.
17. The computer-readable medium of any of aspects 15-16, further comprising instructions to assign unique identifiers to task-relevant objects and integrate these identifiers into task instructions.
18. The computer-readable medium of any of aspects 15-17, further comprising instructions to issue automated error messages when task instructions violate environmental or object constraints.
19. The computer-readable medium of any of aspects 15-18, wherein validation includes determining whether selected objects meet position and size requirements for a task destination.
20. The computer-readable medium of any of aspects 15-19, further comprising instructions to establish bidirectional communication between the user and system for iterative refinement of task instructions.

### Additional Considerations

The following considerations also apply to the foregoing discussion. Throughout this specification, plural instances may implement operations or structures described as a single instance. Although individual operations of one or more methods are illustrated and described as separate operations, one or more of the individual operations may be performed concurrently, and nothing requires that the operations be performed in the order illustrated. These and other variations, modifications, additions, and improvements fall within the scope of the subject matter herein.

It should also be understood that, unless a term is expressly defined in this patent using the sentence “As used herein, the term” “is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for the sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. § 112(f).

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” is employed to describe elements and components of the embodiments herein. This is done merely for convenience and to give a general sense of the invention. This description should be read to include one or at least one, and the singular also includes the plural unless it is obvious that it is meant otherwise.

Upon reading this disclosure, those of skill in the art will appreciate still additional alternative structural and functional designs for implementing the concepts disclosed herein, through the principles disclosed herein. Thus, while particular embodiments and applications have been illustrated and described, it is to be understood that the disclosed embodiments are not limited to the precise construction and components disclosed herein. Various modifications, changes, and variations, which will be apparent to those skilled in the art, may be made in the arrangement, operation, and details of the method and apparatus disclosed herein without departing from the spirit and scope defined in the appended claims.

What is claimed is:

1. A computing system having a processor and a memory having stored thereon computer-executable instructions that, when executed, cause the computing system to:
accept input commands comprising speech and gesture inputs to specify task parameters within a virtual environment;
combine the speech inputs with gesture-based inputs to generate integrated task instructions;
retrieve object and environmental data from a building information model associated with the virtual environment;
verify the integrated task instructions by soliciting user confirmation of parameters interpreted from the integrated task instructions;
validate constraints related to the task instructions using object and environmental data; and
transmit confirmed task execution parameters to a robotic control system for performing tasks in a virtual representation of a construction site.

2. The computing system of claim 1, further comprising instructions to visualize environmental and object data, including geometric and semantic details, within the virtual environment.

3. The computing system of claim 1, further comprising instructions to highlight or annotate objects within the virtual environment when gesture-based input selects targeted objects.

4. The computing system of claim 1, further comprising instructions to automatically correct ambiguous task instructions by querying the user to provide clarification.

5. The computing system of claim 1, further comprising instructions to generate feedback messages indicating errors or inconsistencies in received task instructions.

6. The computing system of claim 1, wherein the constraints validated include spatial compatibility between selected objects and a target environment.

7. The computing system of claim 1, further comprising instructions to store completed task information and disallow repeated task execution involving already-processed objects or locations.

8. A computer-implemented method comprising:
accepting input commands comprising speech and gesture inputs to specify task parameters within a virtual environment;
combining the speech inputs with gesture-based inputs to generate integrated task instructions;
retrieving object and environmental data from a building information model associated with the virtual environment;
displaying a confirmation prompt to verify parameters interpreted from the integrated task instructions;
validating constraints related to the task instructions using object and environmental data; and
transmitting confirmed task parameters to a robotic control system for execution within a construction simulation.

9. The computer-implemented method of claim 8, further comprising visualizing environmental and object data to assist user identification of items or construction zones within a virtual interface.

10. The computer-implemented method of claim 8, further comprising altering visual properties of selected objects, such as color or outline, to indicate acknowledgment of gesture-based input.

11. The computer-implemented method of claim 8, further comprising requesting clarification from a user for incomplete or conflicting task instructions during an input phase.

12. The computer-implemented method of claim 8, further comprising generating instructional feedback indicating task feasibility issues prior to transmitting confirmed task parameters.

13. The computer-implemented method of claim 8, wherein validating constraints includes ensuring compatibility of object attributes such as dimensions and usage history with target parameters.

14. The computer-implemented method of claim 8, further comprising generating an interactive log that displays instructions and their successful or failed validation for troubleshooting purposes.

15. A computer-readable medium having stored thereon instructions that, when executed, cause a computer to:
accept user commands comprising speech and gesture inputs to specify virtual tasks;
process and integrate speech and gesture inputs into task instructions;
retrieve relevant object and contextual data from a building information model;
confirm user intentions by verifying interpreted task details through user interaction;
validate the task against operational constraints; and
output commands to a robotic system for simulated task execution.

16. The computer-readable medium of claim 15, further comprising instructions for dynamically visualizing relevant object details within a virtual scene during user interactions.

17. The computer-readable medium of claim 15, further comprising instructions to assign unique identifiers to task-relevant objects and integrate these identifiers into task instructions.

18. The computer-readable medium of claim 15, further comprising instructions to issue automated error messages when task instructions violate environmental or object constraints.

19. The computer-readable medium of claim 15, wherein validation includes determining whether selected objects meet position and size requirements for a task destination.

20. The computer-readable medium of claim 15, further comprising instructions to establish bidirectional communication between the user and system for iterative refinement of task instructions.
